(19) United States
(12) Patent Application Publication
(10) Pub. No.: US 2014/0156383 A1
(43) Pub. Date: Jun. 5, 2014

(54) AD-WORDS OPTIMIZATION BASED ON PERFORMANCE ACROSS MULTIPLE CHANNELS

(71) Applicant: 24/7 CUSTOMER, INC., Campbell, CA (US)

(72) Inventors: Ravi VIJAYARAGHAVAN, Bangalore (IN); Kranthi Mitra ADUSUMILLI, Hyderabad (IN); Pallipuram V. KANNAN, Los Gatos, CA (US)

(21) Appl. No.: 14/092,868

(22) Filed: Nov. 27, 2013

Related U.S. Application Data
(60) Provisional application No. 61/732,864, filed on Dec. 3, 2012.

(51) Int. Cl. G06Q 30/02

(52) U.S. Cl. CPC G06Q 30/0244; G06Q 30/0256
USPC 705/14.43; 705/14.54

(57) ABSTRACT

In online advertising, ad delivery optimization is derived from ad-words searches. A user performs a keyword search for a product or service. User interactions across multiple channels, e.g. phone, text, email, and so on, and multiple browsers that are used while conducting a search are analyzed to predict user intent. Based on the intent prediction, advertisements that are determined to be the most relevant are displayed along with the search results. The user then clicks through the ads to the websites that are most relevant to his search, for example to make purchases of goods and services.

### CROSS REFERENCE TO RELATED APPLICATIONS

This application claims priority to U.S. provisional patent application Ser. No. 61/732,864 filed Dec. 3, 2012, which application is incorporated herein in its entirety by this reference thereto.

### BACKGROUND OF THE INVENTION

1. Technical Field

The invention relates to online advertising. More particularly, the invention relates to optimization of ad-words based on performance across a plurality of channels, as enabled by identification of intent.

2. Description of the Background Art

Online search engines are typically used to search the Internet for specific content that is of interest to the user. The search engine matches queries created by the user against an index. The search is usually performed by entering keywords, i.e. search terms, that relate to interests of the user into a search tab. The search index consists of the words in each document, plus pointers to their locations within the documents. The user is provided with a list of search results that are ranked in order of relevancy. The most relevant search results are at the top of the list and the least relevant search results are at the bottom of the list.

Usually, the revenue for the search engines is generated by advertisements that are placed on the Web page along with the search results. The user can select the displayed advertisement and be redirected to a Web page for the ad sponsor. Advertisers bid for ad-words or spend money through a bid mechanism to engage such users. Each advertiser may have a particular interest in displaying their advertisements with searches based on particular keywords that may indicate an interest in their product. Apart from the search engine business model, such as pay per impression or pay per click, the amount that advertisers must pay depends on various factors, e.g. where the ad appears, the nature of the ad, the bid placed on the ad by the advertisers, etc.

An organization's goal in advertising is to maximize their return on investment (ROI), i.e. achieve a maximum return for each advertising dollar spent. A performance metric is used to calculate such factors as number of visitors per dollar spent, revenue per dollar spent, number of cart views per dollar spent, number of callers per dollar spent, and so on. To understand the different types of patterns involved in bidding and how much to bid, the organization considers past performance associated with various patterns. For purposes of the discussion herein, a search pattern is based upon a combination of the search term and the nature of the search. For example, entering the search terms in quotes, e.g. “ad word optimization,” searches for an exact match to the search terms, whereas typing the words ad word optimization performs a more generic search. Another example of search pattern types is: red roses vs. roses red (different pattern). Thus, the various combinations of search terms that are possible are each considered to comprise a pattern.

Currently, organizations do not consider performance metrics across multiple channels, for instance chat, voice interactions, e-mail, and so on. Therefore, the intent of the user is not understood at least in part because of the absence of user information across such multiple channels. One reason for this is that existing systems are limited to one channel and, thus, cannot consider the intent of the user across other channels.

### SUMMARY OF THE INVENTION

In online advertising, ad delivery optimization is derived from ad-words searches. A user performs a keyword search for a product or service. User interactions across multiple channels, e.g. phone, text, email, and so on, and multiple browsers that are used while conducting a search are analyzed to predict user intent. Based on the intent prediction, advertisements that are determined to be the most relevant are displayed along with the search results. The user then clicks through the ads to the websites that are most relevant to his search, for example to make purchases of goods and services.

### BRIEF DESCRIPTION OF THE DRAWINGS

FIG. 1 is a block diagram that depicts stages of the user experience;

FIG. 2 is a block schematic diagram showing customer identification according to the invention;

FIG. 3 is a block schematic diagram showing an identifier module according to the invention;

FIG. 4 is a block schematic diagram that shows multichannel user interaction that originates with a user search according to the invention;

FIG. 5 shows the combination of data from multiple user channels and various data models according to the invention;

FIG. 6 is an example of a data model according to the invention;

FIG. 7 is a block diagram illustrates search term, feature-based models according to the invention;

FIG. 8 is a screen shot showing the different elements in ads according to the invention;

FIGS. 9A, 9B, and 9C are graphs that illustrate the change in relative increments with various aspects of a search according to the invention;

FIG. 10 is a graph that illustrates self service conversion versus chat conversion according to the invention; and

FIG. 11 is a block schematic diagram that depicts a machine in the exemplary form of a computer system within which a set of instructions for causing the machine to perform any of the herein disclosed methodologies may be executed.

### DETAILED DESCRIPTION OF THE INVENTION

The result of such spending is hundreds or thousands of messages pitched daily to potential customers. In online advertising, ad delivery optimization is derived from ad-words searches. A user performs a keyword search for a product or service. User interactions across multiple channels, e.g. phone, text, email, and so on, and multiple browsers that are used while conducting a search are analyzed to predict user intent. Based on the intent prediction, advertisements that are determined to be the most relevant are displayed along with the search results. The user then clicks through the ads to the websites that are most relevant to his search, for example to make purchases of goods and services.

Embodiments of the invention use intent prediction to understand such intent better when the customer is searching for goods and services. Ad-words entered when performing a keyword search, along with interactions across multiple communications channels, are analyzed to predict which ads have the highest relevance to the search. By placing highly relevant ads, the customer search is more readily converted into a transaction, thus maximizing return on investment (ROI). Embodiments of the invention also improve online advertising by optimizing ad-words based on performance across multiple channels.

In the e-commerce world, shopping starts with a search from such sources as a search engine. At this stage, analytics can be used to identify the best ads to be associated along with the selected search terms and to bid appropriately for these search terms, for each of the possible sources, e.g. social media, search engines, etc. On clicking the ad user lands on a website. Embodiments of the invention can be used to influence the website by improving the material on the landing page in line with the search term or by directing the user to the appropriate link; and by providing help through the right channel in view of the user's interest as shown by the user's selection of search terms in the past.

During interaction via chat or other means, the knowledge of what users with similar browsing patterns and search terms requested in the past can be used for a contextual invite, contextual information during interaction, offering help through the right channel, and cross sell or up sell, etc. as the user's intent is better known. Finally, attribution to the associated search term is improved, which allows better optimization in future uses of the term.

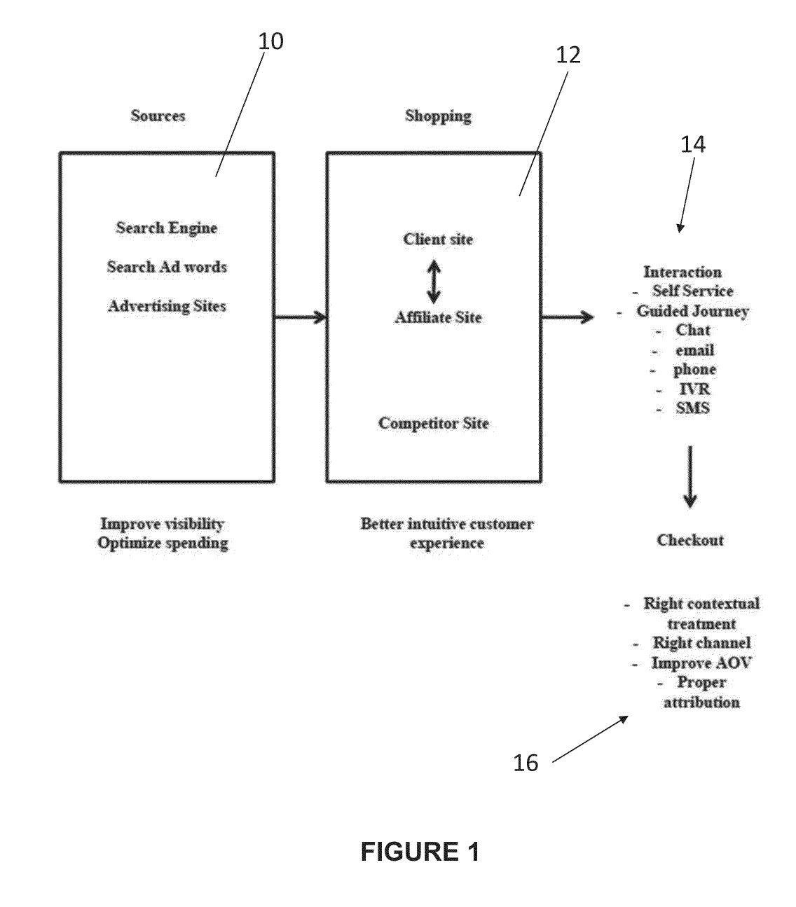

FIG. 1 is a block diagram that depicts the stages of the user experience. As shown in FIG. 1, the user journey can be categorized in three main stages which are sources 10, shopping and/or browsing 12, and interaction 14.

Although the invention is discussed herein in connection with the term “user,” those skilled in the art will appreciate that a “user” can be any person, such as a customer, a prospect, a person interested in a product, a reviewer, and so on.

Initially, the user searches for some information related to a specific interest. The user may interact with one or more search engines. However, in view of the disclosure herein, to derive better optimal value, i.e. ROI optimization, it is necessary that the intent of the user be clearly understood in the context of a plurality of channels, and not just with resort to the user's on-line Web browsing activities during a single session.

For purposes of the discussion herein, the term “channels” refers to a mode of communication or interaction which the user uses to search. For example, a channel may be an instant message service. Thus, a channel is any mode which is used during any specific stage of the user journey, which is part of stages shown in FIG. 1.

The intent of the user can also be better gauged by integrating various data sources. Unique identifiers are created, captured, and/or passed between multiple contact channels, e.g. Web, mobile, interactive voice response (IVR), phone, automotive, television, to identify and tag the user and their context, e.g. history, past behavior, steps progressed, obstacles and/or issues encountered, etc., uniquely (see commonly assigned U.S. patent application Ser. No. 13/897,233, filed May 17, 2013, which application is incorporated herein in its entirety by this reference thereto).

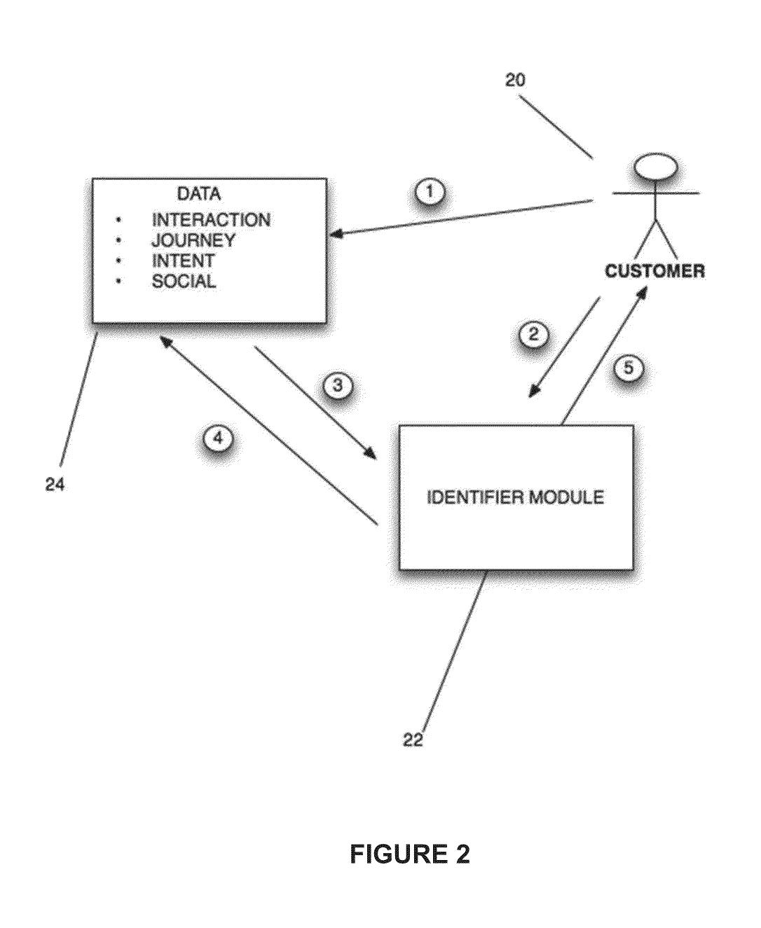

FIG. 2 is a block schematic diagram showing customer identification according to the invention. In FIG. 2, a customer 20 is in communication with an identifier module 22 and a data management system 24 which includes such information, for example, as the customer's interactions, journey, intent, and social actions. In operation, the customer data is stored to the data management system (1), the customer provides any inputs that are required to select an identifier (2), the data management system uses data to associate different sessions and/or journeys to select appropriate options to present to the customer (3), an identifier confidence score is associated with various journeys stored in the data management system (4), and the system provides the customer with options to select an identifier (5).

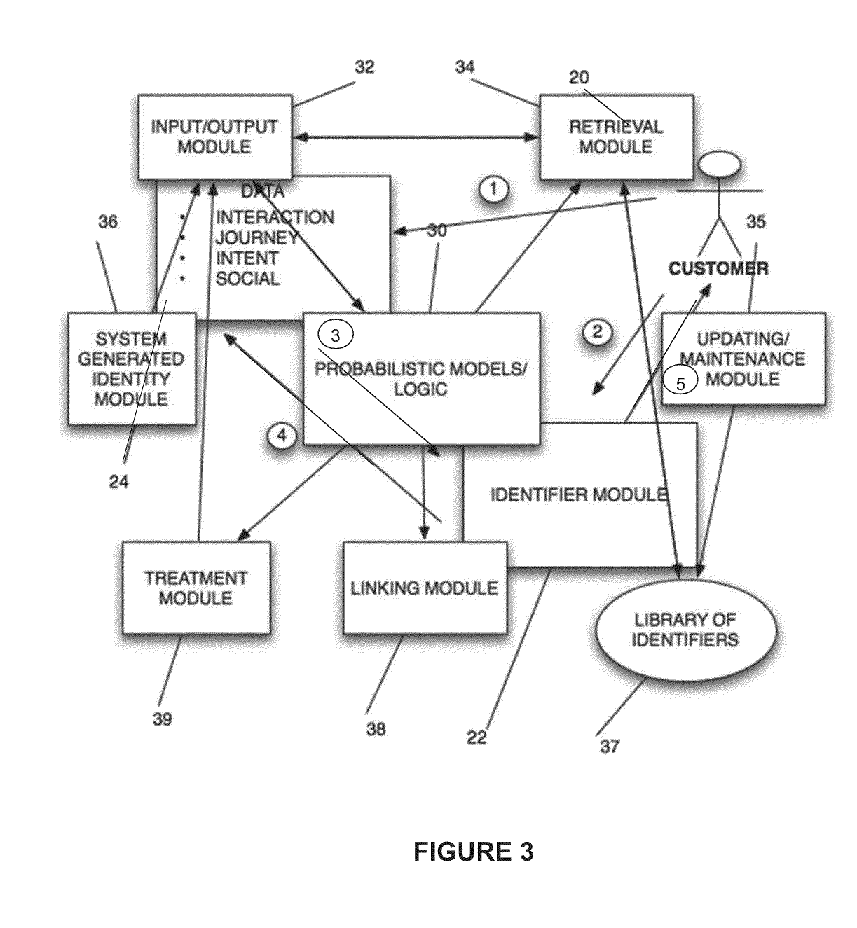

FIG. 3 is a block schematic diagram showing an identifier module according to the invention. In FIG. 3, the data system and customer access the module via an input/output module 32. A retrieval module 34 extracts a list of identities from the library of identifiers 37 to identify the customer. Interaction with the customer is effected by the probabilistic models and logic 30. The treatment module 39 provides the right option to the right customer to get the required data. The linking module 38 links a current interaction with past interaction based upon various identifiers and data. An updating and maintenance module 35 maintains and updates the library of identifiers. The system generated identity module 36 generates customer identities when the customer is not generated by the customer.

Making exact linkages allows for different levels of confidence based on statistical and/or probabilistic scoring of accuracy and/or certainty and unlocking different levels of access, permissions, and empowerments correlated to the level of confidence in the linkage and/or identification of the unique individual. Such approach first identifies characteristics, i.e. data, from within user behavior which can be clustered. The characteristics are used, either deterministically or probabilistically, to identify and label a unique user. A linkage of that unique user is then enabled across channels, devices, within and across sessions.

Once the system is able to track users across session, a unique identifier can be associated with the user, for example ANIs or Web cookies can be identified as belonging to same user. In operation, the user data is stored to a data management system, the user provides any inputs that are required to select an identifier, the data management system uses data to associate different sessions and/or journeys to select appropriate options to present to the user, an identifier confidence score is associated with various journeys stored in the data management system, and the system provides the user with options to select an identifier.

Through this integration of data sources, an enhanced understanding of the intent associated with the search terms keyed in by the user may be obtained. Once the user gets directed to a link pertaining to his interest, he may browse one or more Web pages or any other source. The shopping experience may be enhanced by providing better intuitive user interaction. In an example, a user visits a website offering tour packages; he is greeted by a user representative through a chat portal and given a description of the available tours and packages. He also clears his queries instantly. Based on his expectations, the user may be offered a recommended tour. This interactive mode of response enhances the user experience.

For a further discussion of user context, e.g. journey, intent, actions, steps, experience to date, historical behavior, preferences, etc., as well as predictive techniques applied to such user context see, for example, commonly assigned U.S. patent application Ser. No. 13/239,195, filed Sep. 21, 2011 (Predictive User Service Environment; attorney docket no. 247C0018); Ser. No. 13/349,807, filed Jan. 13, 2012 (Method And Apparatus For Analyzing And Applying Data Related To User Interactions With Social Media; attorney docket no. 247C0023); Ser. No. 13/454,726, filed Apr. 24, 2012 (Method And Apparatus For Enhancing User Service Experience; attorney docket no. 247C0025); Ser. No. 13/461,631, filed May 1, 2012 (Method And Apparatus For Analyzing And Applying Data Related To User Interactions With Social Media; attorney docket no. 247C0026); Ser. No. 13/443,782, filed Apr. 10, 2012 (Method And Apparatus For Predictive Enrichment Of Search In An Enterprise; attorney docket no. 247C0027); Ser. No. 13/599,974, filed Aug. 30, 2012 (User Journey Prediction And Resolution; attorney docket no. 247C0029); and Ser. No. 13/852,942, filed Mar. 28, 2013 (Method And Apparatus For Intent Modeling And Prediction; attorney docket no. 247C0040), each of which application is incorporated herein in its entirety by this reference thereto.

The third stage of user experience (FIG. 1) is the interaction stage 14. During the interaction stage, the user may be guided via a variety of ways, e.g. chat, phone, etc. In an example, the user is provided with an option to make a phone call. The user can then pose queries regarding the prices, availability, delivery dates, and so on. Via these intervention techniques of interaction the conversion rate can be improved.

For this user event 16, predictive analytics can be used to decide the right channel and right time for intervention. Further, predictive analytics can be used to drive better conversion rate and AOV via various techniques, such as data driven cross-sell and up-sell. Also, based on the identified intent, the right contextual treatment can be provided, thus improving the user experience and, in turn, various metrics such as the conversion rate.

Because intervention via the user event 16 is being tracked, proper attribution of sales to the right journey and, in turn, to the appropriate search term is possible. This, in turn, enriches the data for future optimization.

Examples of specific attribution include: where the user searches for a specific product and lands on a particular website; the user browses through the website and sees that the product is out of stock; the user comes back to the website after couple of days from a different device but with same IP, finds the product is in stock, and has a question for which he chats with the agent and gets the information; and the user comes back after couple of days on a second channel device and buys the product.

Using the methodology discussed above, all three journeys can be tied and the sale made can be attributed with the specific search term and also associated with the chat channel. A user journey tied in this manner can not only be used for proper attribution but for future modeling and optimization.

The predictive analytics used for each stage of the user experience help to optimize search-based marketing campaigns and website behavior and thus increase user responses, e.g. user checkout, purchases, clicks to website, signing up for email campaigns etc.; conversions; and clicks.

Each user's predictive score informs advertisers of actions to be taken with that user. The predictive analytics are thus used help generate maximal revenue. For purposes of the discussion herein, the term “revenue” refers to the sum of revenue attributed across channels to various search terms and the amount spent refers to the amount spent on ad words, along with maintaining the program. In embodiments of the invention, this works as a twofold strategy to maximize revenue and minimize expenditure.

In embodiments of the invention, the amount spent is calculated by the formula:

Expenditure per search term=Cost per Click (CPC) of search term*Number of clicks (1)

For purposes of the discussion herein, the CPC is a value that advertisers pay the publisher and/or search engines when an ad is clicked. Essentially, the CPC is known for ads that have been clicked. For new search patterns being considered for bidding, the CPC is estimated using various tools provided by search engines and/or publishers. Where such tools are not available, the CPC of similar search patterns can be used to estimate the CPC of the search pattern being considered

In reality, CPC is governed by factors such as the maximum bid amount of the next bidder, quality scores, click-through rate (CTR), relevancy, and landing page quality. The CPC may also be governed by other variables, such as budget determination, keyword selection, search engine selection, ad creation, and so on. There can also be other factors based on which CPC is determined by various search engines and publishers.

For purpose of the discussion herein, the term “CTR of an advertisement” means the number of clicks on an ad divided by the number of times the ad is shown, i.e. impressions, expressed as a percentage. For example, if a banner ad is delivered 100 times, i.e. 100 impressions, and receives one click, then the CTR rate for the advertisement is 1%.

For purpose of the discussion herein, the term “landing page experience” means the quality of the user's experience when the user gets to the landing page, i.e. the web page they end up on after clicking the ad. The landing page quality can be improved by increasing relevant and original content, transparency, ease of navigation, and better load times. The relevancy may be improved by better tags, language, and context in the landing page. Web mining and analysis of the landing pages on the website can help provide the right content and tags for the site.

Similarly, the CTR may be improved by using proper ads. For example, using better and catchy titles for ad may increase the CTR. Using better framed sentences may increase the CTR, for example using slogans, phrases, indicating discount offers, flavors of the week, and so on. Implementing proper strategies and relevant algorithms and using appropriate Web mining and chat mining techniques also improve the CTR. Web mining helps identify the intent of the user based on the journey undertaken by the user and also by identifying the right landing page for each of the search terms used.

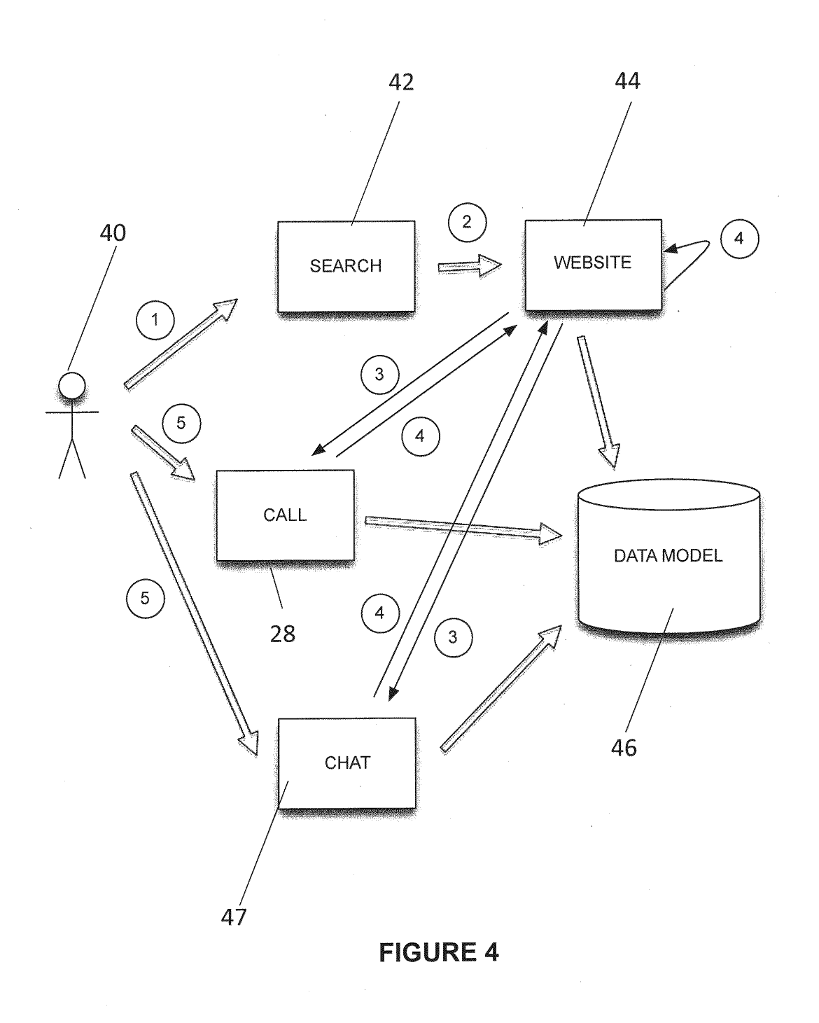

FIG. 4 is a block schematic diagram that shows multichannel user interaction that originates with a user search according to the invention. In FIG. 4, a user 40 performs a search (1) with a search facility 42. The search is executed (2) and the user lands at a website 44, where the user may browse. The user is offered the ability to chat or call (3) via a chat facility 47 or a phone 48, for example depending upon the options available to the user, such as VOIP or Skype. After user interaction (4) directly with the website, via a call, or via a chat session, the user resumes his journey. Thereafter, the user returns (5) via a call or chat session. All of this user interaction information is captured and processed in a data model 46.

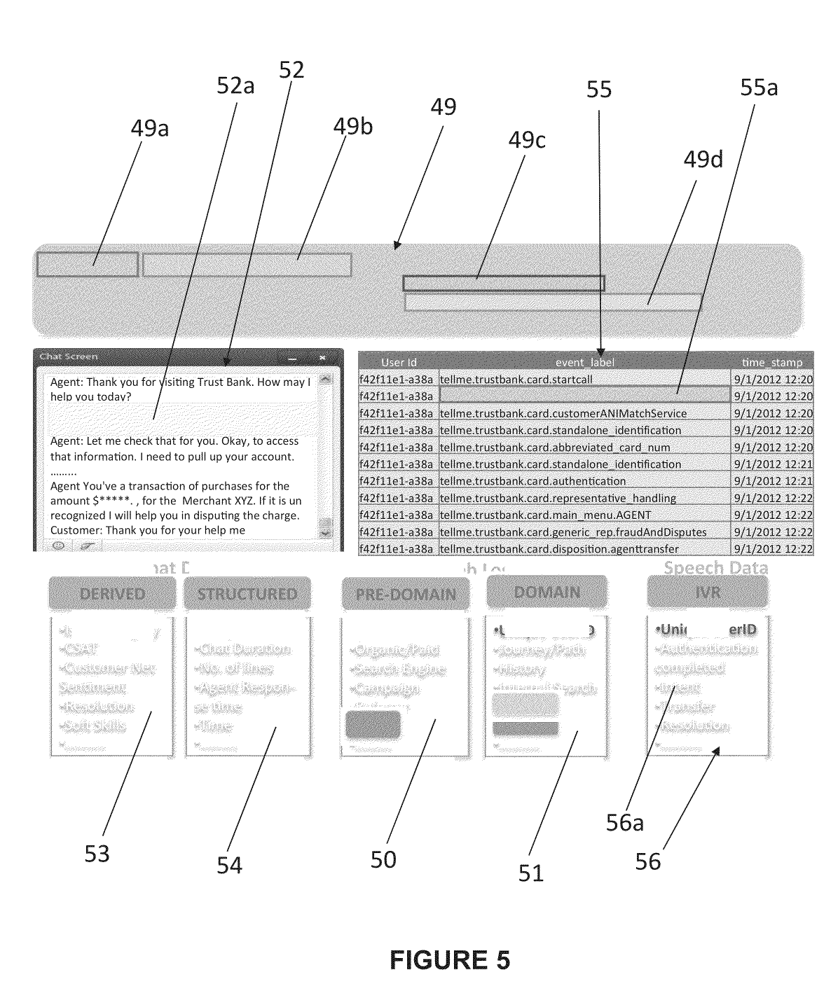

FIG. 5 shows the combination of data from multiple user channels and various data models according to the invention. In FIG. 5, the raw data 49 shown is a sample of unstructured Web log data, where the user is searching for a specific issue, i.e. disputing a credit card transaction with the Trust bank and landing on the appropriate Web page of the Trust bank website. Some of the attributes within this raw that can be extracted are highlighted 49a-49d.

Web logs 50, 51 are sample descriptions of various attributes of the user that can be extracted from the raw data 49. Web logs fall broadly into two categories: website dependent Web logs 51 and independent Web logs 50. Independent Web logs consists of elements such as search term; nature of search term, e.g. paid or organic, search engine, etc.; geography attributes of the user derived from the user's IP address; and so on. Dependent Web logs, among other aspects, consists of a unique identifier which helps tie the data with other sources. Dependent Web logs not only include current user Web browsing data, but also include data from previous user journeys, and ad derived attributes such as whether a search was made, whether a specific product was viewed multiple times, etc.

The chat screen 52 depicts a transcript of sample chat between and agent and the user. The example is for a transaction dispute. This intent can be derived from the highlighted text 52a.

Chat data 53, 54 are derived and structured data attributes that can be obtained from the chat transcript. Structured chat data 54, apart from the unique identifier, consists of data elements relative to the chat session, such as chat duration, number of times, variations in agent response time, etc. Derived chat data 53 consists of text based attributes, such as issues addressed during the chat, whether resolution was reached during the chat, soft skill score for the chat based on the language used in the chat, etc. For some of the attributes in the chat screen heuristics and text mining models are employed.

Semi-processed IVR logs 55 show the intent 55a of the call, which can be deciphered from speech data captured during an IVR session.

IVR data 55 is sample of data attributes associated with IVR log data. The IVR data includes a unique identifier and the call flow, based attributes such as whether authentication was completed, whether the problem was resolved, the intent of the call 56a, etc., as well as other structured attributes such as the length of the call, etc. Some of these attributes may require the use of algorithms or heuristics to extract relevant data.

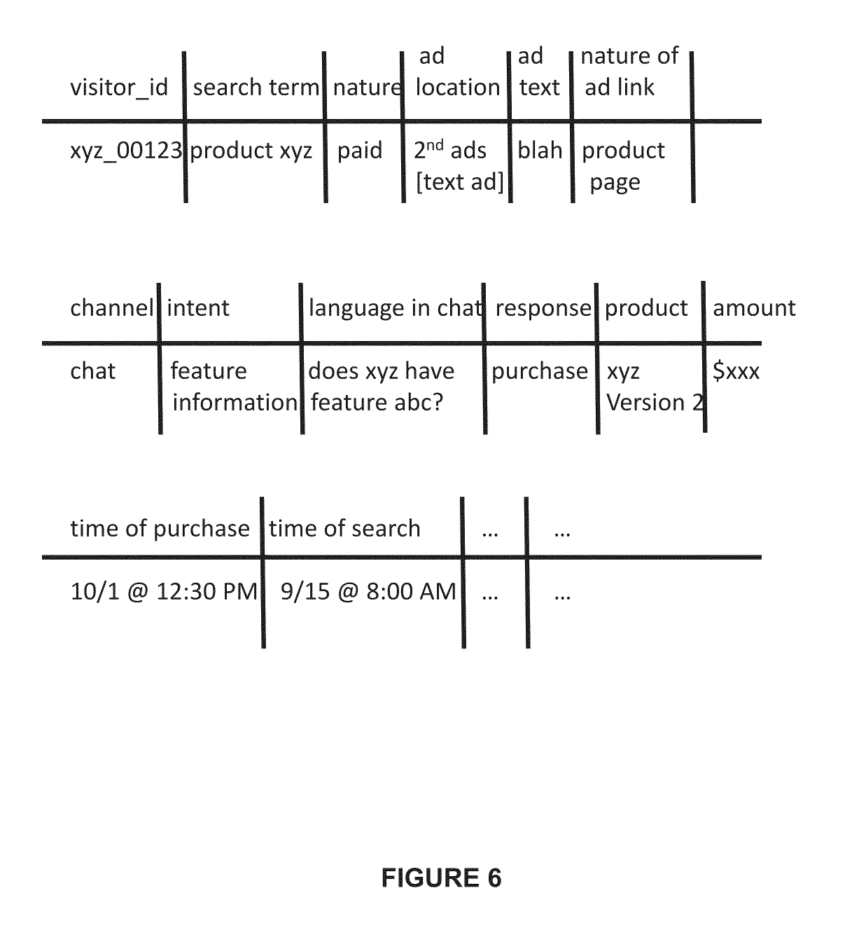

FIG. 6 is an example of a data model according to the invention, where the data model is derived from data such as that described in connection with FIG. 5. The data model comprises an identifier, the visitor id in this case, Web log data (50, 51; see FIG. 5), chat data (53,54; see FIG. 5); and IVR data (56; see FIG. 5). The data model can be extended to include more channels, such as mobile, Omni channel, etc.

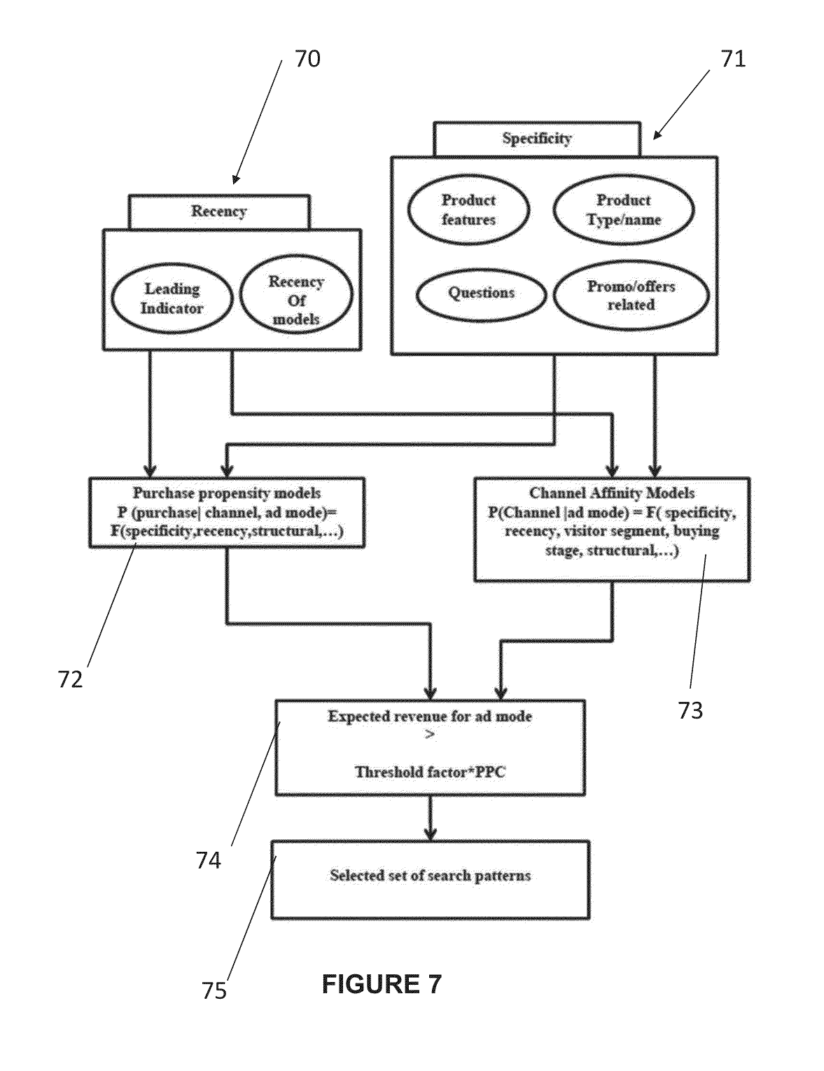

FIG. 7 is a block diagram illustrates search term, feature-based models according to the invention. Factors such as recency 70, e.g. leading indicators and recency of models, and specificity 71, e.g. product features, product type/name, questions, and related promotions and offers. An example of recency of models concerns the search term ‘iPad 5S’ within a couple of months of release of the product. An example of a leading indicator concerns essentially buzz and/or trending topics, e.g. the search term ‘trust bank data breach’ within minutes, hours, and days of a banking user database being hacked. These factors can be derived from the user search term. Search term feature-based models, referred to as purchase propensity models 72 and channel affinity models 73, help identify subset of search patterns on which to bid.

These models are useful when fewer searches are associated with certain search terms. In searching, long tail behavior is observed, i.e. a large number of search terms having a low quantity of searches, but that cumulatively contribute substantially to the overall search volume. To account for such data sparsity, feature based models help cluster the searches. In case of new search terms, e.g. specifically trending search terms, due to the absence of sufficient data from the start, appropriate bids and selection can be made using these feature-based models. The multi-channel data model described above is used for building these models. User response is predicted based on a plurality of factors. Various machine learning or statistical algorithms, such as logistic regression, Naïve Bayes, SVM, Neural networks, etc., can be used to build these models.

For purposes of the discussion herein, the term “purchase propensity” means the propensity of user segments to purchase a particular product. The purchase propensity model takes into consideration factors such as purchase, mode of channel, specificity, recency, and so on. In such case, data is considered across channels. Specificity and recency are considered, for example, with respect to specificity of the product or the issue being searched for and the recency in time of the search, e.g. is the search term a trending search term, etc. An example of specificity is the fact that ‘laptop with fingerprint detection’ is a very feature when specific compared to a generic term, such as ‘laptop.’

For purposes of the discussion herein, the term “outcome of the purchase propensity modeling process” means the likelihood of a user segment to take up specific products. This process takes into account, for example, those events that are likely to trigger this behavior. The outcome of the purchase propensity modeling process informs the development and implementation of more effective, focused strategies, and thus helps maximize profit.

Recency gauges the level of user interest in the site from the standpoint of how frequently visitors return to a site within a time frame. Recency indicates the recent searches term keyed in by the user. Statistics are calculated per unique visitor.

The concept of specificity states that when two or more declarations that apply to the same element, set the same property, and have the same importance and origin, the declaration with the most specific selector takes precedence. Specificity takes into account product features, product type, questions, and related offers for the product, and so on.

Further, the usage of purchase propensity models and channel affinity models helps to estimate the expected revenue for specific ads 74 which ideally is greater than the threshold factor multiplied by the CPC:

Expected revenue>threshold factor*CPC, (1)

where expected revenue is for a specific instance of a search. For optimal selection of search patterns, the set to choose from is the set of search terms which satisfies the above equation. Various factors in the above inequality are explained below.

As with any marketing aspect, there is a budget constraint. Thus, the threshold is set such that minimum revenue is guaranteed, i.e.

Threshold=Minimum revenue/Budget provided.

Minimum revenue is determined based on business constraints and requirements.

For purposes of the discussion herein, expected revenue is defined as:

Rᵢⱼ≡pᵢⱼ*qᵢⱼ (2)

expected revenue per click from interaction via channel j, assuming user entered website via ad mode i, where:
i: various ad modes available;
j: various channels available;
pᵢⱼ: Probability of select channel j for interaction, given user entered website via ad mode i (P(Channel|ad mode)); and
qᵢⱼ: Expected revenue via purchase, given user entered website via ad mode i and interacted via channel j (P(Purchase channel, ad mode)*Average order value given channel j and ad mode i),
   where ad mode includes whether it is a simple text ad, image ad, video ad, etc.; and where different options are available via search engines, such as Google.

In embodiments of the invention, total revenue spent for a specific search pattern is calculated as follows:

$$Total Expected Revenue = {\sum }_{j}^{ } {\sum }_{i}^{ } {R}_{ij} * {CTR}_{i} * {N}_{i} \qquad ( 3 )$$

Where CTRi and Ni are the click-through rate and number of searches for ad mode I, respectively. CTRi and Ni are estimated through various tools and data made available by search engines and publishers. In case of search patterns already being bid for, CTRi is known.

For each of the search patterns satisfying the selection condition above, total expected revenue can be computed as in Equation (3) and expected spend can be obtained from Equation (1). If a set of search patterns is selected, summing Equations (1) and (3) across this set of search term provides total spend and total revenue, respectively. The overall budget available is the constraint to be considered while selecting the set of search terms. Because the possible combination of such sets is potential very huge, optimization algorithms have to be employed to choose an optimal set. Note that multiple optimal sets might exist.

Specifically, a class of optimization algorithms used for Integer programming optimization problems can be used. Because the number of search patterns available for choice is typically huge, greedy heuristic, i.e. selecting the search patterns in order of ROI, i.e. expected revenue per search/CPC, would work. As per this heuristic, search patterns are ordered in decreasing order of ROI, and search patterns are selected from the top until no more budget is available. Certain appropriate variations, such as allocating the remaining budget to a search pattern in case there is not enough budget to cover the total expected spend or to cover a bit of additional search patterns, etc., can be incorporated as appropriate.

Eventually, the selected set of search patterns can be identified.

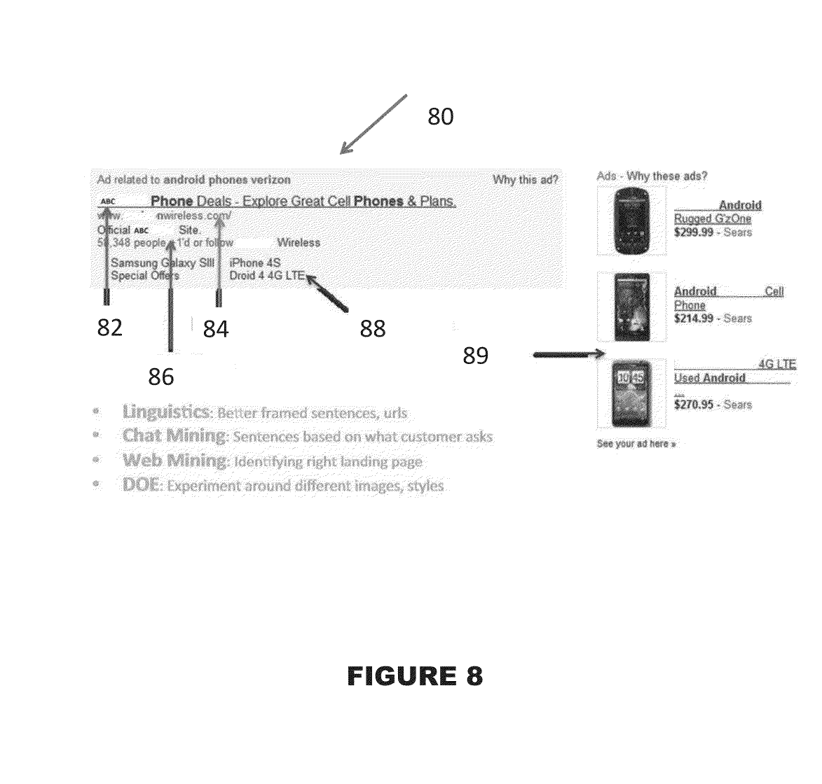

FIG. 8 is a screen shot 80 showing the different elements in ads according to the invention. As shown in FIG. 8, the ad title 82, display URL 84, other links 88, description 86, and images 89 are displayed. The use of linguistics, chat mining, Web mining, images and algorithms, for example via a design of experiments (DOE) approach to different images, styles, etc. based on an improved understanding of intent of the user. The use of multi-channel data for these purposes is key. The ad strategy may be improved by directing to the right channel of engagement, better contextual ads, and landing pages. The relevancy may be improved by better tags, language, and context in the landing page.

In this connection, factors that should be considered for optimizing advertising expenditures can include any of:
Impact of a search term in a specific metric across channels and across multiple visits, in which multiple visits concern the case where the user can search on one day but come back and buy a few days later;
Identifying the right search terms;
Identifying the user's intent; and
Quality of engagement and/or ads.

The process of optimizing advertising expenditures, as discussed herein, provides an opportunity to analyze user behavior. For example, a determination can be made whether a user who searched for a particular product using certain search terms eventually purchased that product. Mapping chat and/or voice data with the search terms keyed in by the user leads to an enhanced identification of the user's intent.

For each user who searches and who, during the course of the journey, interacts via more interactive means such as chat, call, survey, etc., the intent of user can be extracted from the relevant interaction. This is depicted in the previously described data model. For this purpose, various text mining, call flow analysis, and other predictive analytics techniques can be used. Using these extracted intents, the dominant set of intents can be associated with each search pattern.

Consider the following example:

A set of users is searching for a specific brand of electronic products, e.g. XYZ. Many of these users just browsed the website quickly and existed. Of the users who interacted via chat, the primary intent exhibited is in regard to understanding present sales and discounts around a specific product set. Further, in the chat most users used the term ‘any discounts’ rather than the terms ‘deals,’ ‘sales,’ etc. However, when a new product was introduced, the dominant intent in chat of users searching for the same search pattern changed to shipping details around the product. In case of a product launch, this set of users browse through a couple of pages before reaching the appropriate product page. This can be extracted via Web usage mining techniques.

In above example, the following information is extracted using appropriate predictive techniques for users searching via search pattern “XYZ”:
Intent of serious customers is usually regarding price reduction and specifically during a major product introduction around shipping;
The language used usually consist of term “discount;” and
After a product launch, the Web page of interest is the main product page with all details of interest, such as price, specifications, and shipping details.

The overall quality of an ad can also be improved based on these insights in multiple ways, such as use of appropriate key words in a suitable manner, e.g. slogans, catch phrases, etc. Improvement of ad content increases CTR and, in turn, decreases CPC. This provides a better user experience during search and later on the website, and helps to capture the right user by providing appropriate content.

In above example the following can be done to modify the ad content, assuming “XYZ” is a search pattern selected as per previous described optimization process (see FIG. 8):
The ad title 82 and ad text 86 should contain the content about discount and content specific to new product during product launch;
Ad text 86 should contain specific information around shipping during new product launch;
Links 84, 88 should be framed such that primary and secondary intents identified are capture a like product name as part of the URL during product launch;
The main link 84 itself should redirect to the appropriate Web page which has been identified as the page of interest, for example using Web usage mining as described above;
The links 88 should reflect secondary intent, such as redirecting to the main webpage or discount page during product launch; and
The links 88 should contain a link to chat or call, if channel affinity for specific search patterns is high.

Further, based on linguistics the ad text and title itself can be better phrased, as in in FIG. 8, by choosing to show the title phrase from various combinations, such as “Great deals on mobile phones,” “Explore mobile phone deals,” etc. The framing of sentences can be improved via the language chosen by users in chat, surveys, etc. However, experimentation is necessary to learn the optimal combination of various features in an ad 80. This continuous experimentation can be based on various A/B tests or on a more comprehensive design of experiments approach.

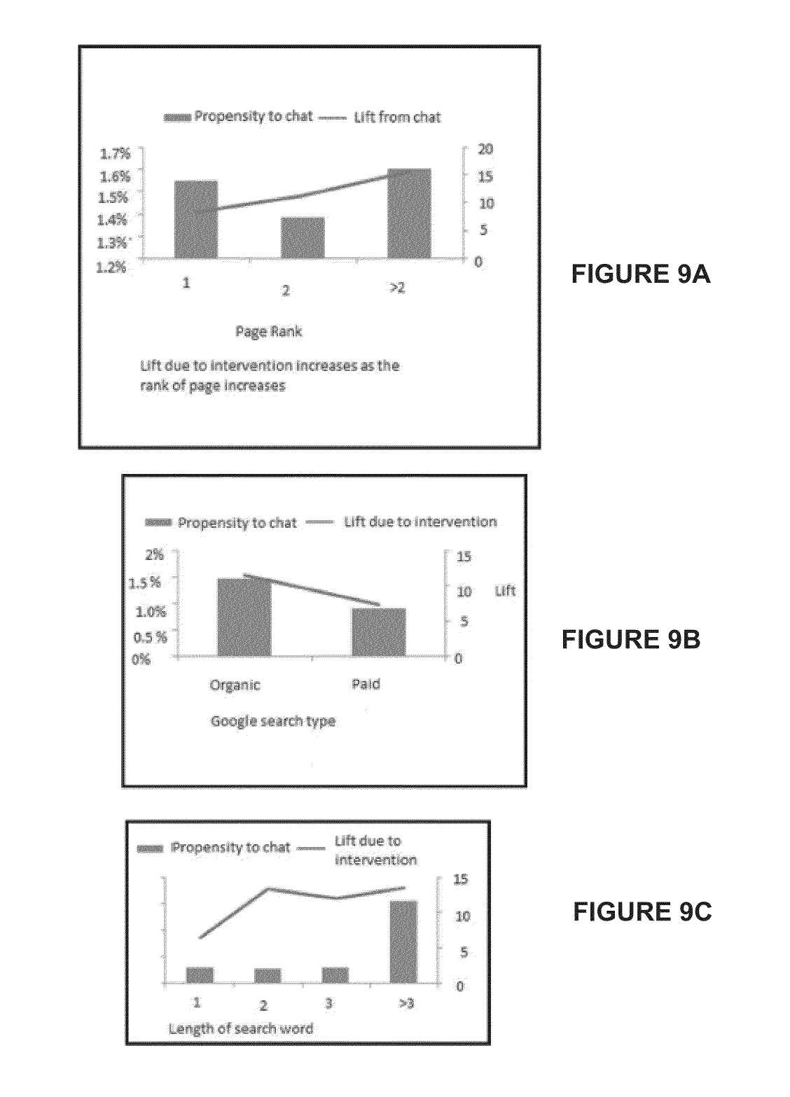

FIGS. 9A, 9B, and 9C are graphs that illustrate the change in relative increments with various aspects of a search according to the invention.

FIG. 9A is a graph of propensity to chat versus lift from chat. As shown in FIG. 9A, the lift due to intervention increases as the rank of page increases. This illustrates that the lower the rank of the search, i.e. a lower associated search result, the more the impact that is provided through chat intervention and, hence, the higher the chat affinity and a higher impact of chat on the user's purchase propensity.

FIG. 9B is a graph of propensity to chat versus search engine type. As shown in FIG. 9B, the user who comes via organic search results is 63% more likely to chat and 57% more likely to buy. Thus, not all searches do better than organic searches, hence better optimal selection is required.

FIG. 9C is a graph of propensity to chat versus length of search word. As shown in FIG. 9C, the need for help increases as the search term becomes more specific. This highlights why specificity is necessary for the models, as described above.

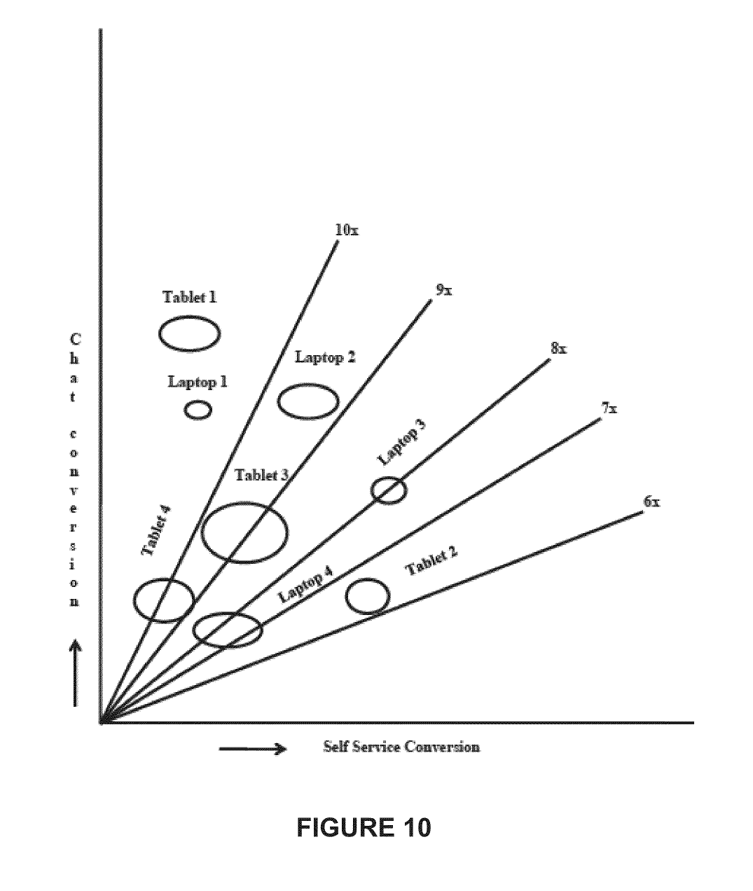

FIG. 10 is a graph that illustrates self service conversion versus chat conversion according to the invention. As shown in FIG. 10, the lift due to chat varies in proportion to specificity. As specificity increases, lift increases, and vice versa. Further, for search terms where the intent of conversion is high, the lift due to intervention is lower. Devices such as tablets and laptops have been depicted in FIG. 10. The volume of a specific device may increase as the lift decreases. This shows that certain search terms have much higher conversion rate via chat compared to self-service, i.e. much higher lift>10× (linear line). For these search terms, chat affinity is much higher.

### Computer Implementation

The embodiments of the invention disclosed herein concern the optimization of ad words based on performance across multiple channels. This allows integration of various data sources to provide a better understanding of the user intent associated with user entered search terms. The embodiments disclosed herein can be implemented through at least one software program running on at least one hardware device and performing network management functions to control the network elements. The network elements shown in FIGS. 1 and 2 include blocks which can be at least one of a hardware device, or a combination of hardware device and software module.

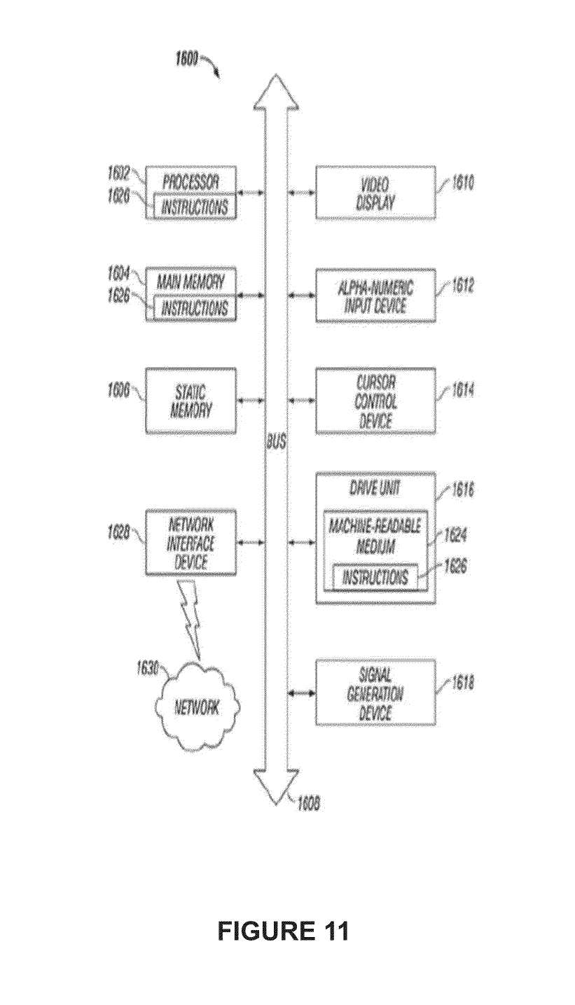

FIG. 11 is a block schematic diagram that depicts a machine in the exemplary form of a computer system 1600 within which a set of instructions for causing the machine to perform any of the herein disclosed methodologies may be executed. In alternative embodiments, the machine may comprise or include a network router, a network switch, a network bridge, personal digital assistant, a cellular telephone, a Web appliance or any machine capable of executing or transmitting a sequence of instructions that specify actions to be taken.

The computer system 1600 includes a processor 1602, a main memory 1604 and a static memory 1606, which communicate with each other via a bus 1608. The computer system 1600 may further include a display unit 1610, for example, a liquid crystal display (LCD). The computer system 1600 also includes an alphanumeric input device 1612, for example, a keyboard; a cursor control device 1614, for example, a mouse; a disk drive unit 1616, a signal generation device 1618, for example, a speaker, and a network interface device 1628.

The disk drive unit 1616 includes a machine-readable medium 1624 on which is stored a set of executable instructions, i.e. software, 1626 embodying any one, or all, of the methodologies described herein below. The software 1626 is also shown to reside, completely or at least partially, within the main memory 1604 and/or within the processor 1602. The software 1626 may further be transmitted or received over a network 1630 by means of a network interface device 1628.

In contrast to the system 1600 discussed above, a different embodiment uses logic circuitry instead of computer-executed instructions to implement processing entities. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer implemented method for advertisement optimization, comprising:
a processor configured for receiving a user search request and user information from two or more channels;
said processor configured for using said search request and user information to predict user intent;
said processor configured for selecting an advertisement for presentation to said user based on said predicted user intent; and
said processor configured for routing the user to a specific channel of said two or more channels for presentation of said advertisement based upon said predicted user intent.

2. The method of claim 1, further comprising:
said processor configured for selecting said advertisement based upon ad words identified in said two or more channels.

3. The method of claim 2, further comprising:
said processor configured for optimizing ad-words based on performance of said advertisement across said two or more channels.

4. A computer implemented method for optimizing online advertising, comprising:
a processor configured for predicting user intent in the context of a plurality of channels with which the user performs a search;
said processor also configured for predicting user intent by integrating a plurality of data sources to gain an enhanced understanding of user intent associated with each search term entered by the user; and
said processor configured for selecting an advertisement for presentation to said user based on said user intent.

5. The method of claim 4, further comprising:
said processor configured for using predictive analytics for each stage of a user journey to optimize any of marketing campaigns and website behavior to increase any of user responses, conversions, and clicks.

6. The method of claim 4, further comprising:
said processor configured for applying each user's predicted intent to determine one or more actions to be taken with each user.

7. The method of claim 4, further comprising:
said processor configured for using predictive analytics for improving any of:
landing page quality by increasing relevant and original content, transparency, ease of navigation and better load times; and
relevancy by providing better tags, language and context in the landing page.

8. The method of claim 4, further comprising:
said processor configured for Web mining to identify user intent based on said user's journey undertaken and to identify as right landing page for each search term entered by said user.

9. The method of claim 4, further comprising:
said processor configured for any of:
analyzing a user journey to reach a desired websites to identify user intent; and
chat mining to identify what queries are posed by the user and to generate relevant results based on said queries.

10. A computer implemented method for optimizing online advertising, comprising:
a processor configured for using search term feature based models to identify a subset of search patterns to bid on based on predicted user intent in the context of a plurality of channels with which the user performs a search;
wherein said models comprise any of purchase propensity models and channel affinity models;
wherein purchase propensity concerns the propensity of user segments to purchase a particular product by taking into consideration factors that comprise any of purchase, mode of channel, specificity, recency and other factors and attributes that are used to predict intent;
wherein said purchase propensity model outcome comprises a likelihood of a customer segment to take an action with regard to specific products, including which events that are likely to trigger said action.

11. The method of claim 10, wherein recency gauges the level of user interest in a website based upon how frequently visitors return to a site within a time frame;
wherein recency indicates recent search terms entered by said user.

12. The method of claim 10, wherein specificity states that when two or more declarations that apply to the same element, and set the same property, and have the same importance and origin, the declaration with the most specific selector takes precedence;
wherein specificity takes into account any of product features, product type, questions, and related offers for the product.

13. The method of claim 10, wherein said usage of purchase propensity models and said channel affinity models help to generate expected revenue per click, in which expected revenue>threshold factor*CPC).

14. The method of claim 13, wherein expected revenue per click from interaction via channel j, assuming the user entered a website via ad mode I comprises:
Rᵢⱼ≡pᵢⱼ*qᵢⱼ
where:
i: various ad modes available;
j: various channels available;
pᵢⱼ: probability of select channel j for interaction, given the user entered the website via ad mode i (P(Channel|ad mode)); and
qᵢⱼ: expected revenue via purchase, given the user entered the website via ad mode i and interacted via channel j (P(Purchase channel, ad mode)*Average order value given channel j and ad mode i);
wherein ad mode includes whether it is a simple text ad, image ad, or video ad;
wherein different options are available via search engines; and
channel refers to mode of engagement.

15. The method of claim 10, further comprising:
said processor configured for using any of linguistics, chat mining, Web mining, images and algorithms to determine user intent.

16. The method of claim 10, further comprising:
said processor configured for improving an ad strategy by any of directing said user to a best channel of engagement and providing better contextual ads and landing pages.

17. The method of claim 10, further comprising:
said processor configured for improving relevancy by providing any of better tags, language, and context in the landing page.

18. The method of claim 10, further comprising:
said processor optimizing ad expenditure based upon predicted user intent and channel affinity.

19. An apparatus for optimization of ad-words, comprising:
providing a processor for determining ad-word performance across multiple channels based upon user search terms;
said processor integrating a plurality of data sources to determine said user's intent associated with said search terms; and
said processor selecting an advertisement for presentation to said user based on said user intent.

20. The apparatus of claim 19, further comprising:
said processor optimizing ad expenditure based upon an analysis of said user's behavior as indicated by whether a user who searched for a particular product using certain search terms eventually purchased the product.

21. The apparatus of claim 19, further comprising:
said processor mapping any of chat and voice data with said user search terms to enhance identification of said user intent.
